(19) United States
(12) Patent Application Publication
(10) Pub. No.: US 2026/0065515 A1
(43) Pub. Date: Mar. 5, 2026

(54) STYLE MATCHING USING LAYER-WISE MASKS

(71) Applicant: ADOBE INC., SAN JOSE, CA (US)

(72) Inventors: Hareesh Ravi, San Jose, CA (US); Ashwin Ramesh, San Jose, CA (US); Xinyang Zhang, Santa Clara, CA (US); Fengbin Chen, Los Gatos, CA (US); Han Guo, Santa Clara, CA (US); Venkata Naveen Kumar Yadav Marri, Newark, CA (US); Ajinkya Gorakhnath Kale, San Jose, CA (US)

(21) Appl. No.: 18/816,765

(22) Filed: Aug. 27, 2024

(51) Int. Cl. G06T 11/00

(52) U.S. Cl. CPC G06T 11/00

(57) ABSTRACT

A method, apparatus, non-transitory computer readable medium, and system for generating style-matched images include obtaining a content prompt and a style prompt. The content prompt includes an object and the style prompt includes a style element. Embodiments then encode the content prompt and the style prompt to obtain a content embedding and a style embedding, respectively. Subsequently, embodiments apply a content mask to the content embedding and a style mask to the style embedding to obtain a weighted content embedding and a weighted style embedding, respectively. Embodiments then generate, using an image generation model, a synthetic image based on the weighted content embedding and the weighted style embedding. The synthetic image depicts the object from the content prompt and the style element from the style prompt.

### BACKGROUND

The following relates generally to image processing, and more specifically to image generation. Image processing is a type of data processing that involves the manipulation of an image to get the desired output, typically utilizing specialized algorithms and techniques. Image processing is used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image generation is a type of image processing that involves the creation of synthetic images. Recently, generative artificial intelligence (AI) models have been developed to generate realistic images. One such model is the Denoising Diffusion Probabilistic Model (DDPM). DDPMs generate samples by transforming an initial random noise distribution into a data distribution over a series of time steps. In some cases, a DDPM can be conditioned on a text description, such that the diffusion process generates images that match the text. In some cases, additional conditioning beyond the text description may be applied to generate images that conform to a particular style, such as “cartoon” or “pixel art.”

### SUMMARY

Embodiments of the inventive concepts described herein include systems and methods for generating an image with content from a text description that is rendered in a style from a style prompt. The style prompt may be an image, a category, or a description. The embodiments encode the content prompt to generate a content embedding, and the style prompt to generate a style embedding. An image generation model then applies the content embedding and the style embedding according to a layer-wise mask, where the layer-wise mask dictates the weighting of each embedding for each layer in an image generation model. According to some aspects, different layers corresponding to different spatial resolutions in an image generation model have varying effects on the transfer of content and the transfer of style into the generated image. Some layers are more efficient at transferring stylistic elements, and some layers are more efficient at transferring structure and content. Through use of the layer-wise masks, embodiments mitigate the transfer of content from the style prompt, and further enable an adjustable style influence parameter that determines the amount of influence from the style prompt on the generated image.

A method, apparatus, non-transitory computer readable medium, and system for image generation are described. One or more aspects of the method, apparatus, non-transitory computer readable medium, and system include obtaining a content prompt and a style prompt, wherein the content prompt includes an object and the style prompt includes a style element; encoding the content prompt and the style prompt to obtain a content embedding and a style embedding, respectively; applying a content mask to the content embedding and a style mask to the style embedding to obtain a weighted content embedding and a weighted style embedding, respectively; and generating, using an image generation model, a synthetic image based on the weighted content embedding and the weighted style embedding, wherein the synthetic image depicts the object from the content prompt and the style element from the style prompt.

A method, apparatus, non-transitory computer readable medium, and system for image generation are described. One or more aspects of the method, apparatus, non-transitory computer readable medium, and system include encoding a content prompt and a style prompt to obtain a content embedding and a style embedding, respectively; identifying a first content mask, a second content mask, a first style mask, and a second style mask, wherein the first content mask and the first style mask correspond to a first layer of an image generation model and the second content mask and the second style mask correspond to a second layer of the image generation model; applying the first content mask and the second content mask to the content embedding and applying the first style mask and the second style mask to the style embedding to obtain a first weighted content embedding, a second weighted content embedding, a first weighted style embedding and a second weighted style embedding; and generating, using the image generation model, a synthetic image based on the first of weighted content embedding, the second weighted content embedding, the first weighted style embedding and the second weighted style embedding, wherein the first layer of the image generation model takes the first weighted content embedding and the first weighted style embedding as input and the second layer of the image generation model takes the second weighted content embedding and the second weighted style embedding as input.

An apparatus, system, and method for image generation are described. One or more aspects of the apparatus, system, and method include at least one processor; at least one memory storing instructions executable by the at least one processor; and an image generation model comprising parameters stored in the at least one memory and configured to generate a synthetic image based on a weighted content embedding and a weighted style embedding, wherein the weighted content embedding is obtained by applying a content mask to a content embedding, and wherein the weighted style embedding is obtained by applying a style mask to a style embedding.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of an image generation model according to aspects of the present disclosure.

FIG. 4 shows an example of a mask component according to aspects of the present disclosure.

FIG. 5A shows an example of a text encoder according to aspects of the present disclosure. FIG. 5B shows an example of an image encoder according to aspects of the present disclosure.

FIG. 6 shows an example of a pipeline for combining multimodal style inputs according to aspects of the present disclosure.

FIG. 7 shows an example of a pipeline for generating images according to aspects of the present disclosure.

FIG. 8 shows an example of a method for generating a synthetic image with a style from a style prompt according to aspects of the present disclosure.

FIG. 9 shows an example of a method for providing a style-matched image to a user according to aspects of the present disclosure.

FIG. 10 shows an example of style-matched synthetic images with varying style strength according to aspects of the present disclosure.

FIG. 11 shows an example of a computing device according to aspects of the present disclosure.

### DETAILED DESCRIPTION

Image generation is frequently used in creative workflows. Historically, users would rely on manual techniques and drawing software to create visual content. The advent of machine learning (ML) has enabled new workflows that automate the image creation process. ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Generative models in ML are algorithms designed to generate new data samples that resemble a given dataset. Generative models are used in various fields, including image generation. They work by learning patterns, features, and distributions from a dataset and then using this understanding to produce new, original outputs.

In some cases, a user wishes to alter the style of a generated image. As used herein, “style” refers to an art style, or one or more aesthetic qualities about an image, as distinguished from its content. One conventional approach to enabling style adjustment is StyleGAN, a type of Generative Adversarial Network (GAN) designed for generating high-resolution images. StyleGAN leverages a concept known as “style space,” where different directions correspond to different stylistic changes in the generated images. This allows for the fine-tuning of style at various levels of the generation process, from coarse features such as overall shape and structure to finer details like textures. However, GAN-based models often struggle with maintaining high levels of realism and coherence, especially under complex or novel style conditions. StyleGAN and its analogues further use a predefined set of style vectors, which represent an explicit set of adjustable characteristics but are limited in their ability to generalize to arbitrary new styles or seamlessly integrate multiple style influences.

Another method for customizing style in generated images involves describing the style directly within a text prompt to a diffusion model. While this approach enables a form of customization, it is inherently limited by the expressiveness and specificity of language. Text-based descriptions can only approximate some aspects of visual style, and relying on text can result in inconsistencies in the interpretation of stylistic elements.

Some diffusion models allow users to upload a reference image to guide the style of the generated image. However, these approaches typically do not distinguish between the content and style elements of the reference image, thereby integrating both into the generated output. This can lead to a mix of unintended content features appearing in the new image. Furthermore, while existing methods like style transfer can apply the style of one image to another, they are primarily designed for modifying existing images rather than generating new stylized images from scratch. Moreover, current diffusion model techniques that incorporate style references lack mechanisms to control the degree of style influence. Users are unable to specify how strongly a style should be applied, resulting in either an overpowering or underwhelming stylistic impact depending on the model's default behavior.

Embodiments of the disclosure improve the accuracy of conventional image generation and style-transfer machine learning models. Systems and methods described herein transfer stylistic elements to predetermined layers of an image generation model. The model uses a content mask and a style mask, which selectively influence the contributions of the content prompt and the style prompt at each layer of the image generation model during the inference process. This approach helps to address the issue of unwanted content features merging into the generated image from the style prompt. Furthermore, some embodiments include a mask component that creates the content mask and the style mask based on a user-configurable “style influence parameter.” This parameter lets the user adjust the degree of style applied, thereby increasing user control.

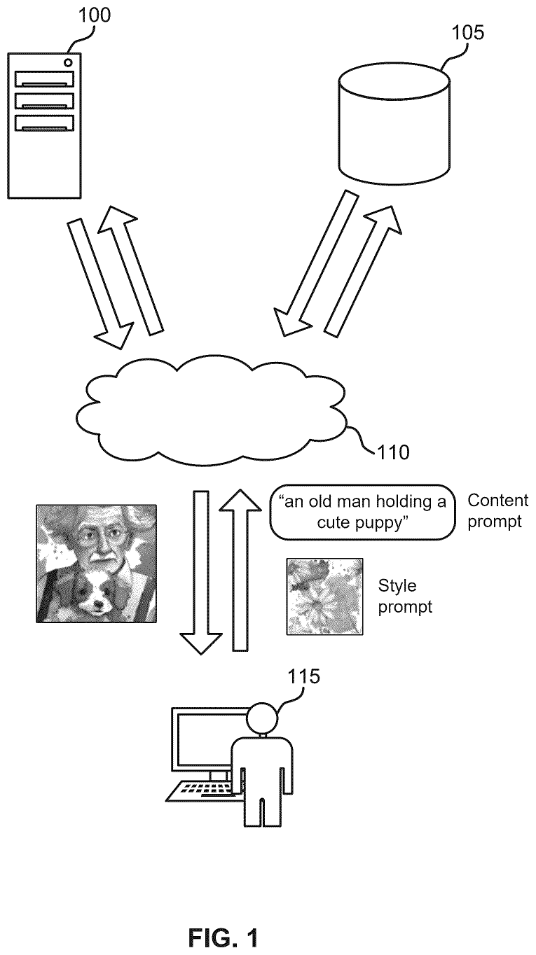

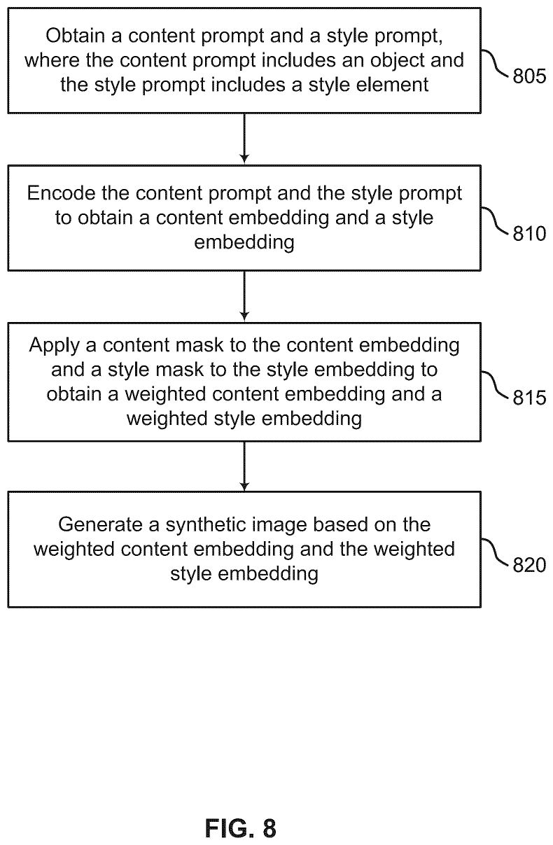

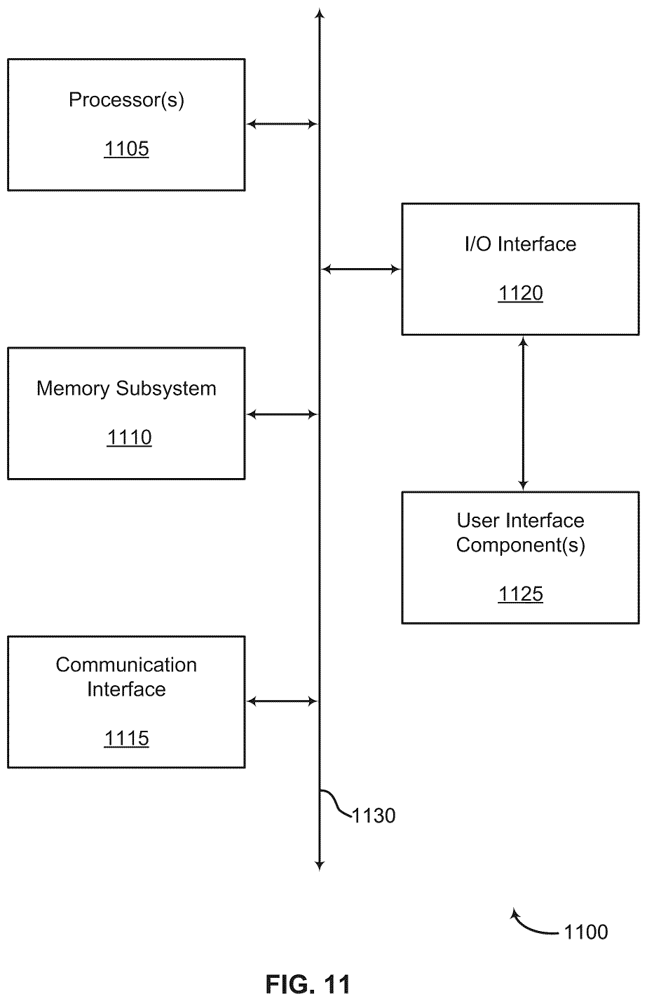

An image processing system is described with reference to FIGS. 1-7. Methods for generating images are described with reference to FIGS. 8-10. A computing device configured to implement an image processing apparatus is described with reference to FIG. 11.

### Image Processing System

An apparatus for image generation is described. One or more aspects of the apparatus include at least one processor; at least one memory storing instructions executable by the at least one processor; and an image generation model comprising parameters stored in the at least one memory and configured to generate a synthetic image based on a weighted content embedding and a weighted style embedding, wherein the weighted content embedding is obtained by applying a content mask to a content embedding, and wherein the weighted style embedding is obtained by applying a style mask to a style embedding.

Some examples of the apparatus, system, and method further include a text encoder configured to generate the content embedding, wherein the text encoder comprises a text adapter trained based on the image generation model. Some examples further include an image encoder configured to generate the style embedding, wherein the image encoder comprises an image adapter trained based on the image generation model. Some examples further include a mask component configured to generate a plurality of content masks and a plurality of style masks corresponding to a plurality of layers of the image generation model.

FIG. 1 shows an example of an image processing system according to aspects of the present disclosure. The example shown includes image processing apparatus 100, database 105, network 110, and user 115. In an example process, user 115 inputs a content prompt and a style prompt. The content prompt describes the content the user wishes to have included in the generated image, and the style prompt describes or provides a reference to the desired style of the generated image. In this case, the user provides a text description as the content prompt and an image as the style prompt. The inputs are sent to image processing apparatus 100 over network 110. The image processing apparatus 100 then performs a generation process using layer-wise masks to generate a synthetic image with content from the content prompt and a style from the style prompt. According to some aspects, the user also supplies a style influence strength parameter, e.g. via a slider element or selectable option, which determines how much influence the style prompt has on the style of the generated image.

Embodiments of image processing apparatus 100 are implemented on a server. For example, one or more components of image processing apparatus 100 may be implemented on a local device, and remaining components may be implemented on a server. A server provides one or more functions users 115 linked by way of one or more of the various networks 110. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 105 is configured to store information used by image processing 100. For example, database 105 may store machine learning model parameters, user configuration or profile settings, generated images, stock images, precomputed embeddings, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, user 115 interacts with a database controller. In other cases, a database controller may operate automatically without user interaction.

Network 110 is used to facilitate the transfer of information between image processing apparatus 100, database 105, and user 115. In some cases, network 110 is referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

According to some aspects, image processing apparatus 100 obtains a content prompt and a style prompt, where the content prompt includes an object and the style prompt includes a style element. In some examples, image processing apparatus 100 encodes the content prompt and the style prompt to obtain a content embedding and a style embedding, respectively. In some aspects, the content prompt includes a text prompt and the style prompt includes an image prompt. In some aspects, the style embedding is retrieved from a style embedding library.

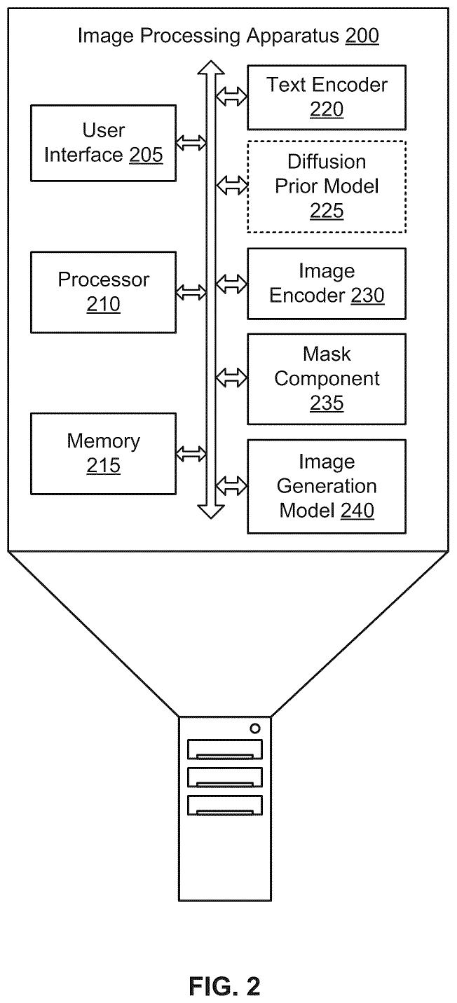

In some examples, image processing apparatus 100 obtains a text prompt. In some examples, image processing apparatus 100 divides the text prompt to obtain the content prompt and the style prompt. In some examples, image processing apparatus 100 uses natural language processing (NLP) techniques to separate the prompt into content and style components. The techniques may be rule-based techniques or, e.g., machine learning (ML) techniques. For example, ML models trained to identify linguistic cues and contextual relevance may be used to classify text into descriptions of objects, scenes, or actions (content prompt) and descriptions that convey aesthetic or artistic qualities (style prompt). Additionally or alternatively, parsing algorithms analyze the text's syntactic structure, identifying noun phrases and adjectives that are related to content or style. Image processing apparatus 100 is an example of, or includes aspects of, the corresponding element described with reference to FIG. 2.

FIG. 2 shows an example of an image processing apparatus 200 according to aspects of the present disclosure. The example shown includes image processing apparatus 200, user interface 205, processor 210, memory 215, text encoder 220, diffusion prior model 225, image encoder 230, mask component 235, and image generation model 240.

User interface 205 enables a user to interact with a device. In some embodiments, user interface 205 includes an audio device, such as an external speaker system, an external display device such as a display screen, or an input device (e.g., remote control device interfaced with the user interface 205 directly or through an IO controller module). In some cases, user interface 205 may be a graphical user interface (GUI).

Processor 210 is configured to execute instructions stored on memory 215. Components of image processing apparatus 200 such as text encoder 220, diffusion prior model 225, image encoder 230, mask component 235, and image generation model 240 may be implemented as sets of instructions (i.e., code) executable by processor 210. In some embodiments, these components are implemented on dedicated circuits. A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 210 is configured to operate memory 215 using a memory controller. In other cases, a memory controller is integrated into processor 210. In some cases, processor 210 is configured to execute computer-readable instructions stored in memory 215 to perform various functions. In some embodiments, processor 210 includes special purpose components for modem processing, baseband processing, digital signal processing, or transmission processing.

Examples of a memory device include random access memory (RAM), read-only memory (ROM), or a hard disk. Examples of memory devices include solid state memory 215 and a hard disk drive. In some examples, memory 215 is used to store computer-readable, computer-executable software including instructions that, when executed, cause processor 210 to perform various functions described herein. In some cases, memory 215 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 215 store information in the form of a logical state.

Some components of image processing apparatus 210, such as text encoder 220, diffusion prior model 225, image encoder 230, and image generation model 240, are implemented using artificial neural networks (ANNs). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Text encoder 220 is configured to generate an embedding from an input text. An embedding is an information-rich vector, or sequence of numbers, that captures the semantic meaning of the text. This vector is derived from the analysis of the text's components-such as words and phrases—and represents these components in a high-dimensional space. Each dimension corresponds to a specific feature or aspect of the input, allowing the embedding to encompass not just the individual words but also the context and nuances conveyed by the overall text. Embodiments of text encoder 220 include, for example, a CLIP text encoder.

Contrastive Language-Image Pre-Training (CLIP) is a neural network that is trained to efficiently learn visual concepts from natural language supervision. CLIP can be instructed in natural language to perform a variety of classification benchmarks without directly optimizing for the benchmarks' performance, in a manner building on “zero-shot” or zero-data learning. CLIP can learn from unfiltered, highly varied, and highly noisy data, such as text paired with images found across the Internet, in a similar but more efficient manner to zero-shot learning, thus reducing the need for expensive and large labeled datasets. A CLIP model can be applied to nearly arbitrary visual classification tasks so that the model may predict the likelihood of a text description being paired with a particular image, removing the need for users to design their own classifiers and the need for task-specific training data. For example, a CLIP model can be applied to a new task by inputting names of the task's visual concepts to the model's text encoder. The model can then output a linear classifier of CLIP's visual representations.

The text encoder 220 and the image encoder 230 may be based on a transformer network. A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

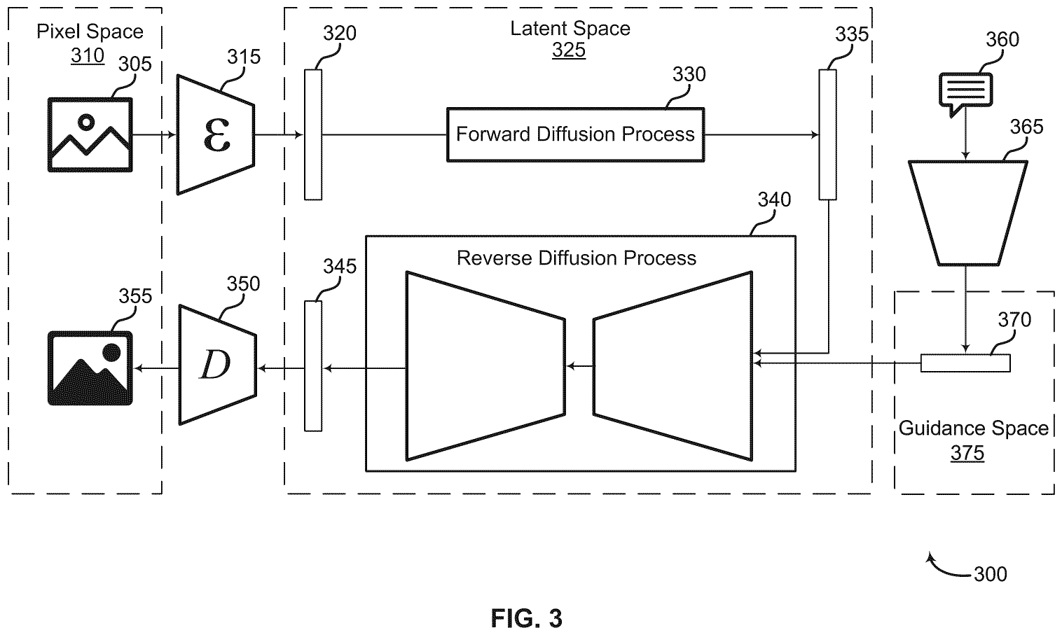

According to some aspects, text encoder 220 is configured to generate the content embedding, wherein the text encoder 220 comprises a text adapter trained based on the image generation model 240. Text encoder 220 is an example of, or includes aspects of, the corresponding element described with reference to FIGS. 3, 5, and 7.

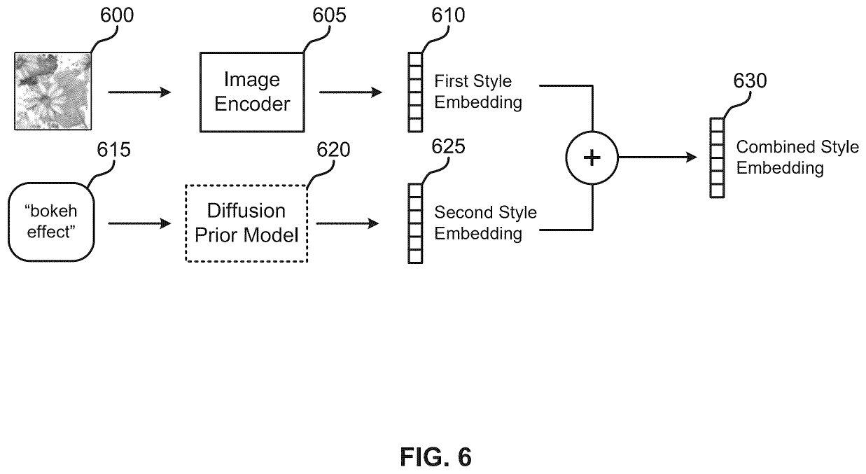

Diffusion prior model 225 is configured to generate an image embedding from an input text. Embodiments of the diffusion prior model 225 process input text and generate an image embedding using reverse diffusion. This process involves encoding text-such as “bokeh effect,” “cartoon,” or “pixel art”-into a vector that captures the visual essence of these styles. Initially, diffusion prior model 225 translates the text into a high-dimensional vector through an encoding mechanism. Then, diffusion prior model 225 uses reverse diffusion to update an initial noisy state and iteratively refine this state into a structured image embedding that reflects the style described by the text. In this way, diffusion prior model 225 allows the image processing apparatus 200 handle input texts as style prompts. Diffusion prior model 225 is an example of, or includes aspects of, the corresponding element described with reference to FIG. 6. In at least one embodiment, diffusion prior model 225 is implemented on an apparatus different from image processing apparatus 200.

Image encoder 230 is configured to generate an image embedding from an input image. Embodiments of image encoder 230 include, for example, a convolutional neural network (CNN), a Vision Transformer network (ViT), a CLIP-encoder, or a combination thereof. According to some aspects, image encoder 230 is configured to generate the style embedding, wherein the image encoder 230 comprises an image adapter trained based on the image generation model 240. Image encoder 230 is an example of, or includes aspects of, the corresponding element described with reference to FIGS. 3, and 5-7.

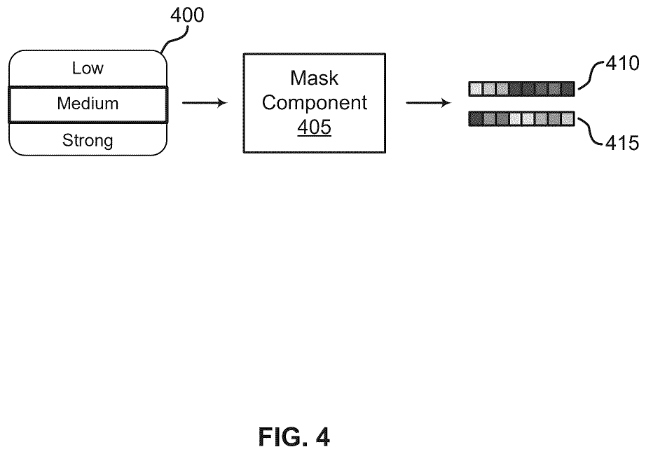

Mask component 235 generates a content mask and a style mask. The content mask and the style mask include a set of values that determine the weighting of the content embedding and the style embedding that is applied to each layer of the image generation model 240. According to some aspects, mask component 235 obtains a style influence parameter, where the content mask and the style mask are based on the style influence parameter. In some aspects, the content mask and the style mask satisfy a joint condition. For example, in some aspects, the content mask and the style mask include scalar values that sum to one. For example, a first value of the content mask corresponding to a first layer of image generation model 240 may sum to one when added to a first value of the style mask that also corresponds to the first layer of image generation model 240, and the second values of each mask may similarly sum to one, and so forth. In some examples, mask component 235 identifies a diffusion timestep, where the content mask and the style mask are based on the diffusion timestep. Mask component 235 is an example of, or includes aspects of, the corresponding element described with reference to FIG. 4.

Image generation model 240 is configured to generate images based on a text prompt. Embodiments of image generation model 240 include a diffusion model. According to some aspects, image generation model 240 applies a content mask to the content embedding and a style mask to the style embedding to obtain a weighted content embedding and a weighted style embedding, respectively. In some examples, image generation model 240 generates, a synthetic image based on the weighted content embedding and the weighted style embedding, where the synthetic image depicts the object from the content prompt and the style element from the style prompt.

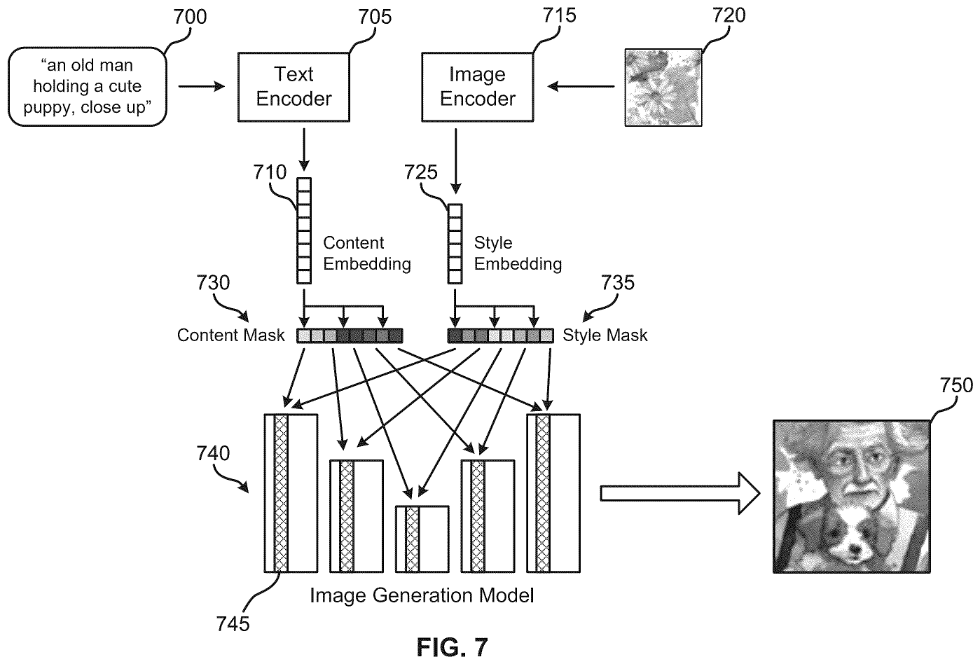

In some examples, image generation model 240 applies a set of content masks to the content embedding and a set of style masks to the style embedding to obtain a set of weighted content embeddings and a set of weighted style embeddings, respectively, where each of the set of layers of the image generation model 240 takes a corresponding weighted content embedding of the set of weighted content embeddings and a corresponding weighted style embedding of the set of weighted style embeddings as input. In some aspects, the content embedding and the style embedding are provided to a cross-attention layer of the image generation model 240. Image generation model 240 is an example of, or includes aspects of, the corresponding element described with reference to FIGS. 3 and 7.

FIG. 3 shows an example of an image generation model according to aspects of the present disclosure. The example shown includes guided latent diffusion model 300, original image 305, pixel space 310, image encoder 315, original image features 320, latent space 325, forward diffusion process 330, noisy features 335, reverse diffusion process 340, denoised image features 345, image decoder 350, output image 355, text prompt 360, text encoder 365, guidance features 370, and guidance space 375. Image encoder 315 is an example of, or includes aspects of, the corresponding element described with reference to FIGS. 2, and 5-7. Text encoder 365 is an example of, or includes aspects of, the corresponding element described with reference to FIGS. 2, 5, and 7.

In some examples, diffusion models are based on a neural network architecture known as a U-Net. The U-Net takes input features having an initial resolution and an initial number of channels, and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt describing content to be included in a generated image. For example, a user may provide the prompt “a person playing with a cat”. In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(xₜ|xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , X_{T} using a Markov chain. The Markov chain gradually adds Gaussian noise to the data to obtain the approximate posterior q(x_{1:T}|x₀) as the latent variables are passed through a neural network such as a U-Net, where x₁, . . . , X_{T} have the same dimensionality as x₀.

The neural network may be trained to perform the reverse process. During the reverse diffusion process, the model begins with noisy data X_{T}, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) = p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , X_{T} represent noisy images, and x represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n−1 to an actual image (or image features), such as the image at stage n−1 or the original input image. For example, given observed data x, the diffusion model may be trained to minimize the variational upper bound of the negative log-likelihood-log p_{θ}(x) of the training data. The training system then updates parameters of the model based on the comparison. For example, parameters of a U-Net may be updated using gradient descent. Time-dependent parameters of the Gaussian transitions can also be learned.

FIG. 4 shows an example of a mask component 405 according to aspects of the present disclosure. The example shown includes style influence parameter 400, mask component 405, content mask 410, and style mask 415. Mask component 405 is an example of, or includes aspects of, the corresponding element described with reference to FIG. 2.

In the example shown, mask component 405 receives a style influence parameter 400. The style influence parameter 400 may indicate a strength of a style to be applied in a generated image. For example, a user may select a strength from a GUI element such as a drop-down menu or a slider element. Then, mask component 405 generates both content mask 410 and style mask 415 based on style influence parameter 400. For example, mask component 405 may select a first plurality of values within content mask 410 and second plurality of values within style mask 415 according to the indicated style strength. In some embodiments, each of the first plurality of values may sum to one with a corresponding value of the second plurality of values. An example of different sets of the first plurality of values, that is, values of content mask 410, for three different style strengths is given by Table 1. Table 1 is an example of 3 different content masks for different indicated style strengths:

TABLE 1
Example content masks for “low,” “medium,” and
“high” style influence parameters.

| Style Influence | |
|---|---|
| Strength | Layer-wise content mask |
| “Low” | [0.4, 0.6, 0.4, 0.6, 0.6, 1.0, 1.0, 1.0, 1.0, 1.0, 1.0, 0.4, 0.4, 0.4, 0.4, 0.4, |
| | 0.4, 1.0, 1.0, 1.0, 0.5, 1.0, 1.0, 0.6, 0.6, 0.4, 0.4, 0.6, 0.6, 0.6, 0.4, 0.4] |
| “Medium” | [0.2, 0.4, 0.2, 0.4, 0.4, 1.0, 1.0, 1.0, 1.0, 1.0, 1.0, 0.2, 0.2, 0.2, 0.2, 0.2, |
| | 0.2, 1.0, 1.0, 1.0, 0.5, 1.0, 1.0, 0.4, 0.4, 0.2, 0.2, 0.4, 0.4, 0.4, 0.2, 0.2] |
| “Strong” | [0.0, 0.2, 0.0, 0.2, 0.2, 1.0, 1.0, 1.0, 1.0, 1.0, 1.0, 0.0, 0.0, 0.0, 0.0, 0.0, |
| | 0.0, 1.0, 1.0, 1.0, 0.5, 1.0, 1.0, 0.2, 0.2, 0.0, 0.0, 0.2, 0.2, 0.2, 0.0, 0.0] |

The sets of the second plurality of values, that is, values of the style mask 415, may sum to 1 with each corresponding value from the first plurality of values. For example, Table 2 is an example of 3 different style masks for different indicated style strengths:

TABLE 2
Example style masks for “low,” “medium,” and “high”
style influence parameters.

| Style Influence | |
|---|---|
| Strength | Layer-wise style mask |
| “Low” | [0.6, 0.4, 0.6, 0.4, 0.4, 0.0, 0.0, 0.0, 0.0, 0.0, 0.0, 0.6, 0.6, 0.6, 0.6, 0.6, |
| | 0.6, 0.0, 0.0, 0.0, 0.5, 0.0, 0.0, 0.4, 0.4, 0.6, 0.6, 0.4, 0.4, 0.4, 0.6, 0.6] |
| “Medium” | [0.8, 0.6, 0.8, 0.6, 0.6, 0.0, 0.0, 0.0, 0.0, 0.0, 0.0, 0.8, 0.8, 0.8, 0.8, 0.8, |
| | 0.8, 0.0, 0.0, 0.0, 0.5, 0.0, 0.0, 0.6, 0.6, 0.8, 0.8, 0.6, 0.6, 0.6, 0.8, 0.8] |
| “Strong” | [1.0, 0.8, 1.0, 0.8, 0.8, 0.0, 0.0, 0.0, 0.0, 0.0, 0.0, 1.0, 1.0, 1.0, 1.0, 1.0, |
| | 1.0, 0.0, 0.0, 0.0, 0.5, 0.0, 0.0, 0.8, 0.8, 1.0, 1.0, 0.8, 0.8, 0.8, 1.0, 1.0] |

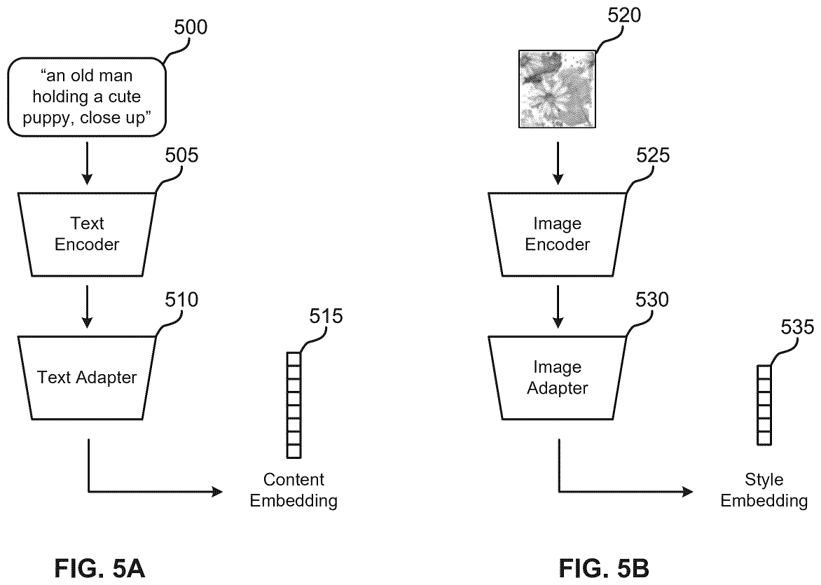

FIG. 5A shows an example of a text encoder according to aspects of the present disclosure. FIG. 5B shows an example of an image encoder according to aspects of the present disclosure. The examples shown include content prompt 500, text encoder 505, text adapter 510, content embedding 515, style prompt 520, image encoder 525, image adapter 530, and style embedding 535. Text encoder 505 is an example of, or includes aspects of, the corresponding element described with reference to FIGS. 2, 3, and 7. Image encoder 525 is an example of, or includes aspects of, the corresponding element described with reference to FIGS. 2, 3, 6, and 7.

In FIG. 5A, a text encoder 505 receives content prompt 500. In this example, content prompt 500 is a text description of an image to be generated. A user may provide content prompt 500 via a user interface as described with reference to FIG. 2. Then, text encoder 505 encodes content prompt 500 to generate an intermediate text embedding. Embodiments of text encoder 505 include a transformer-based model, such as Flan-T5 or GPT-2. In some embodiments, such as this example, the encoding process further includes text adapter 510. Text adapter 510 may include an ANN, such as a feed-forward multi-layer perceptron (MLP). Text adapter 510 receives the intermediate text embedding as input and outputs content embedding 515. According to some aspects, text adapter 510 is used to improve the text-to-image task, and is otherwise unrelated to style-matching or style transfer. Some embodiments therefore omit text adapter 510.

In FIG. 5B, image encoder 525 receives style prompt 520. In this example, style prompt 520 is a reference image that depicts a style that the user wishes to transfer into a generated image. A user may provide style prompt 520 via a user interface as described with reference to FIG. 2. For example, the user may upload or otherwise specify a reference image. Then, image encoder 525 encodes style prompt 520 to generate an intermediate image embedding. Embodiments of image encoder 505 include, for example, the CLIP image encoder, a CNN, or a transformer-based image encoder such as a vision transformer network (ViT). In some embodiments, such as this example, the encoding process further includes image adapter 530. Image adapter 530 may include an ANN similar to text adapter 510. Image adapter 530 receives the intermediate image embedding as input and outputs style embedding 535. According to some aspects, image adapter 530 is used to improve the text-to-image task, and is otherwise unrelated to style-matching or style transfer. Some embodiments therefore omit image adapter 530.

FIG. 6 shows an example of a pipeline for combining multimodal style inputs according to aspects of the present disclosure. The example shown includes first style prompt 600, image encoder 605, first style embedding 610, second style prompt 615, diffusion prior model 620, second style embedding 625, and combined style embedding 630. Image encoder 605 is an example of, or includes aspects of, the corresponding element described with reference to FIGS. 2, 3, 5, and 7. Diffusion prior model 620 is an example of, or includes aspects of, the corresponding element described with reference to FIG. 2.

In some cases, a user may wish to combine styles from multiple inputs. For example, a user may wish to combine styles from multiple reference images, or from a reference image and a style text description. The style embedding may be generated from an image, a text, or a combined style input that includes a text and an image. When a style text is provided, the system may encode the text to generate a text embedding, and then may use diffusion prior model 620 to transform the text embedding into an image embedding in a shared embedding space. In this way, the system generates a style embedding (as an image embedding) from an input text. For an input style image, the system my use image encoder 605 to generate the style embedding directly.

In this example, a user specifies first style prompt 600 and second style prompt 615. First style prompt 600 is a reference image depicting a first style. Image encoder 605 then encodes first style prompt 600 to generate first style embedding 610. Image encoder 605 may do so via the pipeline described with reference to FIG. 5B.

Second style prompt 615 is a text that describes a second style different from the first style. In this example, second style prompt 615 includes the words “bokeh effect.” A diffusion prior model 620, such as the one described in FIG. 2, may be used to generate a second style embedding 625 that captures stylistic aspects from the description in second style prompt 615. For example, the diffusion prior model 620 may be trained or configured to generate an image embedding from a text embedding of second style prompt 615. According to some aspects, the first style embedding 610 and the second style embedding 625 may be in the same space, e.g., may have the same dimensionality, and may have directions in the space that represent the same or similar aspects from the inputs. The generated second style embedding 625 may be stored in a database for later use, and associated with the second style prompt 615.

Then, the first style embedding 610 and the second style embedding 625 may be combined to generate a combined style embedding 630 that captures stylistic aspects from both styles. For example, the first style embedding 610 and the second style embedding 625 may be averaged, concatenated, added, or otherwise combined to generate combined style embedding 630. Combined style embedding 630 may then be used as the style embedding to introduce the first style and the second style into a generated image.

FIG. 7 shows an example of a pipeline for generating images according to aspects of the present disclosure. The example shown includes content prompt 700, text encoder 705, content embedding 710, style prompt 715, image encoder 720, style embedding 725, content mask 730, style mask 735, image generation model 740, and synthetic image 750. Text encoder 705 is an example of, or includes aspects of, the corresponding element described with reference to FIGS. 2, 3, and 5. Image encoder 720 is an example of, or includes aspects of, the corresponding element described with reference to FIGS. 2, 3, 5, and 6. Image generation model 740 is an example of, or includes aspects of, the corresponding element described with reference to FIG. 2.

In this example, a user provides content prompt 700 and style prompt 715. Content prompt 700 is a text description of the content to be generated, and style prompt 715 is a reference image depicting a style the user wishes to include in the generated image. As used herein, “style” refers to an art style, or one or more aesthetic qualities about an image, as distinguished from its content. A text encoder 705 encodes content prompt 700 to generate content embedding 710, and an image encoder 720 encodes style prompt 715 to generate style embedding 725. Additional detail regarding the encoding process is described with reference to FIGS. 5A-5B.

Content mask 730 dictates the weighting of content embedding 710 applied at each layer of image generation model 740, and similarly style mask 735 dictates the weighting of style embedding 725 at each layer of image generation model 740. Content mask 730 and style mask 735 may be generated using a mask component, e.g. as described with reference to FIG. 4. Accordingly, by applying values from content mask 730 to content embedding 710, embodiments generate a plurality of weighted content embeddings. Embodiments similarly generate a plurality of weighted style embeddings by applying values from style mask 735 to style embedding 725.

In one aspect, image generation model 740 includes cross-attention layer 745. The weighted content embeddings and the weighted style embeddings may be applied to a cross-attention layer 745 in each resolution block of image generation model 740. In the machine learning field, an attention mechanism is a method of placing differing levels of importance on different elements of an input. Calculating attention may involve three basic steps. First, a similarity between query and key vectors obtained from the input is computed to generate attention weights. Similarity functions used for this process can include dot product, splice, detector, and the like. Next, a softmax function is used to normalize the attention weights. Finally, the attention weights are weighed together with their corresponding values. In the context of an attention network, the key and value are typically vectors or matrices that are used to represent the input data. The key is used to determine which parts of the input the attention mechanism should focus on, while the value is used to represent the actual data being processed.

In cross-attention, this mechanism is used to balance the influences of both content and style embeddings. Here, the key and value are vectors or matrices that represent different aspects of the input data-′keys' help identify which elements should be emphasized, while ‘values’ hold the actual data related to those elements. Cross-attention allows the model to merge style information, content information, and the latest sample information in each iteration of the denoising process.

Embodiments may apply larger weighting to the content embedding 710 in cross-attention layers of image generation model 740 that are more influential in the synthesized content of synthetic image 750. Embodiments may apply larger weighting to the style embedding 725 in cross-attention layers of image generation model 740 that are more influential in the synthesized style of synthetic image 750. In this way, embodiments ensure that only stylistic elements, and not structure or content, are transferred from style prompt 715.

### Generating Images

A method for image generation is described. One or more aspects of the method include obtaining a content prompt and a style prompt, wherein the content prompt includes an object and the style prompt includes a style element; encoding the content prompt and the style prompt to obtain a content embedding and a style embedding, respectively; applying a content mask to the content embedding and a style mask to the style embedding to obtain a weighted content embedding and a weighted style embedding, respectively; and generating, using an image generation model, a synthetic image based on the weighted content embedding and the weighted style embedding, wherein the synthetic image depicts the object from the content prompt and the style element from the style prompt.

In some aspects, the content prompt comprises a text prompt and the style prompt comprises an image prompt. Some examples of the method, apparatus, non-transitory computer readable medium, and system further include obtaining a text prompt. Some examples further include dividing the text prompt to obtain the content prompt and the style prompt. In some aspects, the style embedding is generated using a diffusion prior model. In some aspects, the style embedding is retrieved from a style embedding library.

Some examples of the method, apparatus, non-transitory computer readable medium, and system further include obtaining a plurality of content masks and a plurality of style masks corresponding to a plurality of layers of the image generation model. Some examples further include applying the plurality of content masks to the content embedding and the plurality of style masks to the style embedding to obtain a plurality of weighted content embeddings and a plurality of weighted style embeddings, respectively, wherein each of the plurality of layers of the image generation model takes a corresponding weighted content embedding of the plurality of weighted content embeddings and a corresponding weighted style embedding of the plurality of weighted style embeddings as input. In some aspects plurality of weighted content embeddings and a plurality of weighted style embeddings are provided to cross-attention layers of the image generation model.

Some examples include encoding a content prompt and a style prompt to obtain a content embedding and a style embedding, respectively; identifying a first content mask, a second content mask, a first style mask, and a second style mask, wherein the first content mask and the first style mask correspond to a first layer of an image generation model and the second content mask and the second style mask correspond to a second layer of the image generation model; applying the first content mask and the second content mask to the content embedding and applying the first style mask and the second style mask to the style embedding to obtain a first weighted content embedding, a second weighted content embedding, a first weighted style embedding and a second weighted style embedding; and generating, using the image generation model, a synthetic image based on the first of weighted content embedding, the second weighted content embedding, the first weighted style embedding and the second weighted style embedding, wherein the first layer of the image generation model takes the first weighted content embedding and the first weighted style embedding as input and the second layer of the image generation model takes the second weighted content embedding and the second weighted style embedding as input.

In some aspects, the content mask and the style mask satisfy a joint condition. In some aspects, the content mask and the style mask comprise scalar values that sum to one. Some examples of the method, apparatus, non-transitory computer readable medium, and system further include obtaining a style influence parameter, wherein the content mask and the style mask are based on the style influence parameter. Some examples further include identifying a diffusion timestep, wherein the content mask and the style mask are based on the diffusion timestep.

An additional method for image generation is described. One or more aspects of the method include encoding a content prompt and a style prompt to obtain a content embedding and a style embedding, respectively; identifying a plurality of content masks and a plurality of style masks corresponding to a plurality of layers of an image generation model; applying the plurality of content masks to the content embedding and the plurality of style masks to the style embedding to obtain a plurality of weighted content embeddings and a plurality of weighted style embeddings, respectively; and generating, using the image generation model, a synthetic image based on the plurality of weighted content embeddings and the plurality of weighted style embeddings, wherein each of the plurality of layers of the image generation model takes a corresponding weighted content embedding of the plurality of weighted content embeddings and a corresponding weighted style embedding of the plurality of weighted style embeddings as input. In some aspects, the image generation model comprises a diffusion model.

In some aspects, each content mask of the plurality of content masks comprises a scalar value that sums to one with a value of a corresponding style mask of the plurality of style masks. Some examples of the method, apparatus, non-transitory computer readable medium, and system further include obtaining a style influence parameter, wherein the plurality of content masks and the plurality of style masks are based on the style influence parameter. Some examples further include identifying a diffusion timestep, wherein the plurality of content masks and the plurality of style masks are based on the diffusion timestep.

FIG. 8 shows an example of a method 800 for generating a synthetic image with a style from a style prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains a content prompt and a style prompt, where the content prompt includes an object and the style prompt includes a style element. In some cases, the operations of this step refer to, or may be performed by, an image processing apparatus as described with reference to FIGS. 1 and 2. For example, the image processing apparatus may receive the content prompt from a user interface, in which a user types, selects, or otherwise identifies the content prompt. The image processing apparatus may similarly receive the style prompt from the user interface. For example, the user may select or upload a style image, or select a style from a list of styles. The list of styles may include, for example, “pixel art,” “steampunk,” “golden hour,” “bokeh-effect,” “hyper-realistic,” and the like.

At operation 810, the system encodes the content prompt and the style prompt to obtain a content embedding and a style embedding, respectively. In some cases, the operations of this step refer to, or may be performed by, a text encoder and an image encoder of the image processing apparatus as described with reference to FIGS. 2 and 5A-5B.

At operation 815, the system applies a content mask to the content embedding and a style mask to the style embedding to obtain a weighted content embedding and a weighted style embedding, respectively. In some cases, the operations of this step refer to, or may be performed by, an image generation model as described with reference to FIGS. 2 and 7.

The image generation model may retrieve the content mask and the style mask from a mask component, which may generate the masks according to the pipeline described with reference to FIG. 4. According to some aspects, the content mask and the style mask respectively determine the influence of the content embedding and the style embedding at each layer of the image generation model during a generative iteration. The masks may include a plurality of scalar mask values. For example, the system may identify a first content mask and a second content mask of the content mask, and a first style mask and a second style mask of the style mask. The first content mask and the first style mask correspond to a first layer of the image generation model, and the second content mask and the second style mask correspond to a second layer of the image generation model. The masks may be applied to their respective embeddings. For example, the system may apply the first content mask and the second content mask to the content embedding to obtain a first weighted content embedding and a second weighted content embedding. The system may also apply the first style mask and the second style mask to the style embedding to obtain a first weighted style embedding and a second weighted style embedding.

At operation 820, the system generates, using the image generation model, a synthetic image based on the weighted content embedding and the weighted style embedding, where the synthetic image depicts the object from the content prompt and the style element from the style prompt. In some cases, the operations of this step refer to, or may be performed by, an image generation model as described with reference to FIGS. 2 and 7. The image generation model may generate the synthetic image using the weighted embeddings. For example, the first layer of the image generation model may take the first weighted content embedding and the first weighted style embedding as input, and the second layer of the image generation model may take the second weighted content embedding and the second weighted style embedding as input. The generation process may be, for example, a reverse diffusion process as described with reference to FIG. 3. Additional detail regarding the incorporation of the weighted embeddings during generation is provided with reference to FIG. 7.

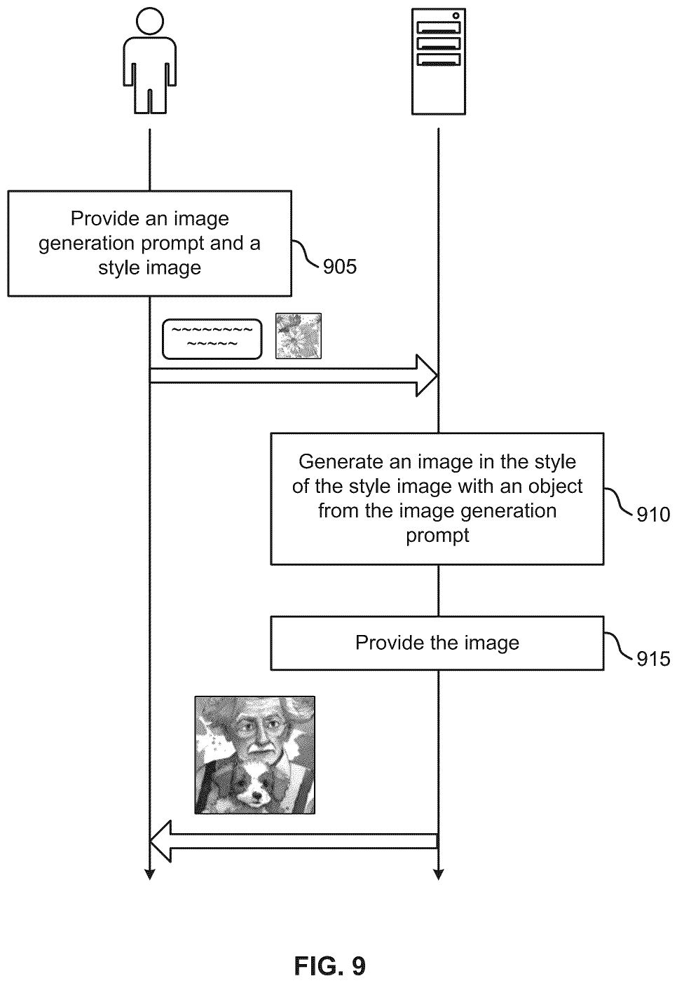

FIG. 9 shows an example of a method 900 for providing a style-matched image to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the user provides an image generation prompt and a style image. The user may provide the prompts via a user interface as described with reference to FIG. 2. According to some aspects, the user further indicates a desired style strength by using a style influence parameter.

At operation 910, the system generates an image in the style of the style image with an object from the image generation prompt. The system may use an image generation model, conditioned with weighted content and style embeddings, to ensure the image includes content from the image generation prompt and adopts the style of the style image.

At operation 915, the system provides the image. The system may do so, for example, via the user interface. According to some aspects, the system may further save any generated embeddings from operation 910 for use in future generations.

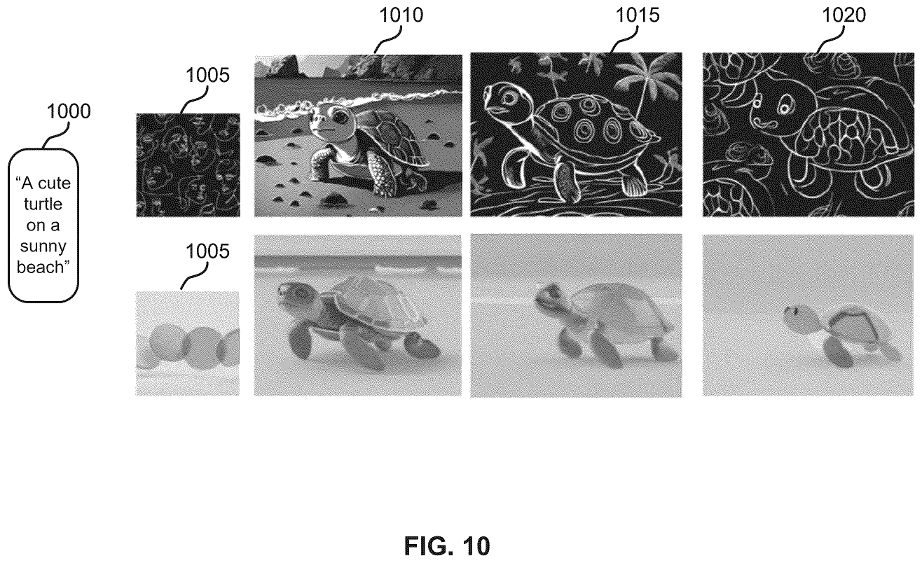

FIG. 10 shows an example of style-matched synthetic images with varying style strength according to aspects of the present disclosure. The example shown includes content prompt 1000, style prompt 1005, low strength result 1010, medium strength result 1015, and high strength result 1020.

FIG. 10 shows a total of six results from a single content prompt 1000. The content prompt 1000 describes the content of the images to be generated. Style prompt 1005 includes two styles, as indicated by a first reference image that shows a white line-drawing style on a black background, and a second reference image that shows four translucent jelly-like disks on a bright background. Then, the results for ‘low,’ ‘medium,’ and ‘high’ style strengths are shown in low strength results 1010, medium strength results 1015, and high strength results 1020, respectively, for both styles.

As apparent from the results, when a user selects a “low” style strength, the style is only lightly transferred to the synthesized image. For example, in the top result of low strength results 1010, a turtle is generated with white-colored outlines, but still contains gradations of shades of grey. In the bottom result of low strength results 1010, the generated turtle includes some of the translucent aspects from the second reference image, but still persists many identifying features of a turtle. The stylistic aspects from each style are more strongly transferred in the medium strength results 1015. In high strength results 1020, for example, the styles are strongly applied. For example, the “disconnected lines” aspect of the first reference image is transferred into the top result of high strength results 1020. The simplicity of the jelly-like disks is transferred to the bottom result of high strength results 1020. It will be appreciated that a user may wish to choose between the low, medium, and high style influences according to various creative workflows.

FIG. 11 shows an example of a computing device 1100 according to aspects of the present disclosure. The example shown includes computing device 1100, processor(s) 1105, memory subsystem 1110, communication interface 1115, I/O interface 1120, user interface component(s), and channel 1130.

In some embodiments, computing device 1100 is an example of, or includes aspects of, image processing apparatus 100 of FIG. 1. In some embodiments, computing device 1100 includes one or more processors 1105 are configured to execute instructions stored in memory subsystem 1110 to obtain a content prompt and a style prompt, wherein the content prompt includes an object and the style prompt includes a style element; encode the content prompt and the style prompt to obtain a content embedding and a style embedding, respectively; apply a content mask to the content embedding and a style mask to the style embedding to obtain a weighted content embedding and a weighted style embedding, respectively; and generate, using an image generation model, a synthetic image based on the weighted content embedding and the weighted style embedding, wherein the synthetic image depicts the object from the content prompt and the style element from the style prompt.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote control device interfaced with a user interface directly or through the I/O controller), or a combination thereof. In some cases, user interface component(s) 1125 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a content prompt and a style prompt, wherein the content prompt includes an object and the style prompt includes a style element;
encoding the content prompt and the style prompt to obtain a content embedding and a style embedding, respectively;
applying a content mask to the content embedding and a style mask to the style embedding to obtain a weighted content embedding and a weighted style embedding, respectively; and
generating, using an image generation model, a synthetic image based on the weighted content embedding and the weighted style embedding, wherein the synthetic image depicts the object from the content prompt and the style element from the style prompt.

2. The method of claim 1, wherein:
the content prompt comprises a text prompt and the style prompt comprises an image prompt.

3. The method of claim 1, wherein obtaining the content prompt and the style prompt comprises:
obtaining a text prompt; and
dividing the text prompt to obtain the content prompt and the style prompt.

4. The method of claim 1, wherein:
the style embedding is generated using a diffusion prior model.

5. The method of claim 1, wherein:
the style embedding is retrieved from a style embedding library.

6. The method of claim 1, further comprising:
obtaining a plurality of content masks and a plurality of style masks corresponding to a plurality of layers of the image generation model; and
applying the plurality of content masks to the content embedding and the plurality of style masks to the style embedding to obtain a plurality of weighted content embeddings and a plurality of weighted style embeddings, respectively, wherein each of the plurality of layers of the image generation model takes a corresponding weighted content embedding of the plurality of weighted content embeddings and a corresponding weighted style embedding of the plurality of weighted style embeddings as input.

7. The method of claim 1, further comprising:
obtaining a style influence parameter, wherein the content mask and the style mask are based on the style influence parameter.

8. The method of claim 1, wherein:
the content mask and the style mask satisfy a joint condition.

9. The method of claim 8, wherein:
the content mask and the style mask comprise scalar values that sum to one.

10. The method of claim 1, further comprising:
identifying a diffusion timestep, wherein the content mask and the style mask are based on the diffusion timestep.

11. The method of claim 1, wherein:
the content embedding and the style embedding are provided to a cross-attention layer of the image generation model.

12. A method comprising:
encoding a content prompt and a style prompt to obtain a content embedding and a style embedding, respectively;
identifying a first content mask, a second content mask, a first style mask, and a second style mask, wherein the first content mask and the first style mask correspond to a first layer of an image generation model and the second content mask and the second style mask correspond to a second layer of the image generation model;
applying the first content mask and the second content mask to the content embedding and applying the first style mask and the second style mask to the style embedding to obtain a first weighted content embedding, a second weighted content embedding, a first weighted style embedding and a second weighted style embedding; and
generating, using the image generation model, a synthetic image based on the first of weighted content embedding, the second weighted content embedding, the first weighted style embedding and the second weighted style embedding, wherein the first layer of the image generation model takes the first weighted content embedding and the first weighted style embedding as input and the second layer of the image generation model takes the second weighted content embedding and the second weighted style embedding as input.

13. The method of claim 12, wherein:
the image generation model comprises a diffusion model.

14. The method of claim 12, wherein:
the first content mask and the second content mask each comprise a scalar value that sums to one with a value of a corresponding value from the first style mask or the second style mask.

15. The method of claim 12, further comprising:
obtaining a style influence parameter, wherein the first content mask, the second content mask, the first style mask, and the second style mask are based on the style influence parameter.

16. The method of claim 12, further comprising:
identifying a diffusion timestep, wherein the first content mask, the second content mask, the first style mask, and the second style mask are based on the diffusion timestep.

17. An apparatus comprising:
at least one processor;
at least one memory storing instructions executable by the at least one processor; and
the apparatus further comprising an image generation model comprising parameters stored in the at least one memory and configured to generate a synthetic image based on a weighted content embedding and a weighted style embedding, wherein the weighted content embedding is obtained by applying a content mask to a content embedding, and wherein the weighted style embedding is obtained by applying a style mask to a style embedding.

18. The apparatus of claim 17, further comprising:
a text encoder configured to generate the content embedding, wherein the text encoder comprises a text adapter trained based on the image generation model.

19. The apparatus of claim 17, further comprising:
an image encoder configured to generate the style embedding, wherein the image encoder comprises an image adapter trained based on the image generation model.

20. The apparatus of claim 17, further comprising:
a mask component configured to generate a plurality of content masks and a plurality of style masks corresponding to a plurality of layers of the image generation model.
